(19) United States
(12) Patent Application Publication
(10) Pub. No.: US 2017/0104299 A1
(43) Pub. Date: Apr. 13, 2017

(54) Illuminated Power Strip

(71) Applicant: Kimberly Vu, Lansdowne, PA (US)

(72) Inventor: Kimberly Vu, Lansdowne, PA (US)

(21) Appl. No.: 15/289,904

(22) Filed: Oct. 10, 2016

Related U.S. Application Data
(60) Provisional application No. 62/239,404, filed on Oct. 9, 2015.

(51) Int. Cl. H01R 13/717; H01R 13/70; H01R 24/78; H01R 25/00; H01R 24/30

(52) U.S. Cl. CPC H01R 13/7175; H01R 25/006; H01R 24/30; H01R 24/78; H01R 13/70; H01R 2103/00

(57) ABSTRACT

A power strip for powering a variety of electronics and devices is provided. The power strip comprises a housing having a top surface, a pair of end surfaces, and a pair of side surfaces. A three pronged master plug extends from the housing for providing power to the power strip. An activation switch is mounted on the housing with the activation switch alternatingly powering on and powering off the power strip. At least one power socket is mounted to the housing. At least one lighting device is mounted to the housing for illuminating the at least one power socket. The at least one lighting device illuminates the at least one power socket improving the visibility of the at least one power socket and expediting appliance and device connection.

### CLAIM OF PRIORITY

This patent application claims priority under 35 USC 119 (e) (1) from U.S. Provisional Patent Application Ser. No. 62/239,404 filed Oct. 9, 2015, of common inventorship herewith entitled, “Power Strip,” which is incorporated herein by reference as though the same were set forth in its entirety.

### FIELD OF THE INVENTION

The present invention pertains to the field of electrical accessories, and more specifically to the field of power strips.

### BACKGROUND OF THE INVENTION

Electronic appliances and machines have become such integral parts of household life that it is difficult to imagine having to live without them. Whether enjoying an entertaining program on television, warming a late dinner in the microwave, or surfing the Internet on a personal computer, many people consider these devices a necessity rather than a luxury. Disparate items such as toasters, lamps and hair dryers are all powered by electricity and are invaluable aids that allow daily lives to function smoothly and efficiently. Essential and convenient, these gadgets have bettered the lives of millions of people in countless ways.

While electrical appliances are must haves for any household, their use has drawbacks. In particular, the lengthy, dangling cords that serve to power these devices are an unattractive and unsafe distraction in any room. Furnished with lamps, clocks, and stereo and TV equipment, stately living rooms are rendered unsightly by piles of electrical cords snaking along the floor. Tidy kitchen countertops can appear unkempt due to masses of cords powering blenders, coffee makers and can openers. Another problem presented by cords, particularly extension cords, is they are easily disconnected from a parent cord or outlet with only a slight, inadvertent pull.

To help combat these aforementioned drawbacks, many individuals employ multi outlet power strips, known as surge protectors, to help consolidate many plugs into one neat, central location. A power strip is a block of electrical sockets that attaches to the end of a flexible cable, allowing multiple electrical devices to be powered from a single electrical socket. Power strips are often used when many electrical devices are in proximity to each other, such as for audio video and computer systems. Power strips include a circuit breaker to interrupt the flow of electric current in case of an overload or a short circuit. Connecting electrical cords to a power strip is sometimes a challenging endeavor, especially when the power strip is tucked into darkened niches behind furniture. Unable to clearly see each outlet, users find themselves wasting valuable time fumbling to properly fit a plug into a companion receptacle.

The prior art has put forth several designs for power strips. Among these are:

U.S. Pat. No. 7,635,273 to Elliot Buzil, Andrew Hung and Ken Ku describes power supply devices having illuminated receptacles. Some or all of the receptacles are encircled or otherwise circumscribed by a lighting member. The lighting member may be a continuous strip of material, such as an electroluminescent laminate. The lighting member may illuminate the receptacles regardless of whether the receptacles themselves are currently powered. Although the power supply device is in a no or low light environment, or when the device is plugged in but is turned off, a user may easily identify where the receptacles are, which ones are available, and which equipment is plugged into which receptacles. The lighting member may be color coded according to a surge protection rating for the power supply device. The user can immediately identify which power supply devices have a given surge protection, and can therefore distinguish among different power supply devices having similar physical configurations.

U.S. Pat. No. 6,089,893 to Dongxiao Yu and Joseph DiOrio describes an illuminated electrical receptacle which employs a lamp containing electroluminescent materials which are made to produce visible light upon the application of AC current to such materials. The lamp is flat with apertures which permit the blades of two electrical plugs to pass through from a face plate to a base containing electrical contacts. The face plate is formed of materials which permit the light produced to pass through all or selected parts of the face plate or outline the face plate or its apertures.

U.S. Pat. No. 4,617,613 to Keith Q. Rice describes an illuminated electrical outlet cover plate having an illuminating device mounted on the plate and connected electrically to tentacular electrical conductors located and designed in such a manner as to automatically make the necessary and proper electrical contact with the heads of the feed and ground terminal screws and ground bracket. The multiple tentacular electrical contact design for supplying electrical power to the illuminating device has no moving parts, except the spring properties of the tentacular conductors and is the novel and new feature that permits the flexibility and adaptability necessary for installation to all conventional electrical outlets regardless of manufacturer. The novel tentacular contact design for supplying electrical power to the illuminating device on the cover plate makes installation as simple as installing a non-illuminated cover plate.

None of these prior art references describe the present invention.

### SUMMARY OF THE INVENTION

It is an object of the present invention to provide an improved surge protector that comprises illuminated outlets making it easier to see plug sockets and expedite appliance and device connection.

The present invention is a power strip for powering a variety of electronics and devices. The power strip comprises a housing having a top surface, a pair of end surfaces, and a pair of side surfaces. A three pronged master plug extends from the housing for providing power to the power strip. An activation switch is mounted on the housing with the activation switch alternatingly powering on and powering off the power strip. At least one power socket is mounted to the housing. At least one lighting device is mounted to the housing for illuminating the at least one power socket. The at least one lighting device illuminates the at least one power socket improving the visibility of the at least one power socket and expediting appliance and device connection.

In addition, the present invention includes a method for powering a variety of electronics and devices. The method comprises providing a housing having a top surface, a pair of end surfaces, and a pair of side surfaces, extending a three pronged master plug from the housing, mounting an activation switch on the housing, alternatingly powering on and powering off the power strip, mounting a least one power socket to the housing, mounting at least one lighting device to the housing for illuminating the power sockets, illuminating the power sockets, and improving the visibility of the power sockets to expedite appliance and device connection.

The present invention further includes a power strip for powering a variety of electronics and devices. The power strip comprises a housing having a top surface, a pair of end surfaces, and a pair of side surfaces. A three pronged master plug extends from one of the end surfaces of the housing for providing power to the power strip. A surge protector is mounted within the housing. An activation switch is mounted on the top surface of the housing with the activation switch alternatingly powering on and powering off the power strip. A plurality of power sockets is mounted to the housing. At least one lighting device is mounted to the housing for illuminating the plurality of power sockets. The at least one lighting device illuminates the plurality of power sockets improving the visibility of the plurality of power sockets and expediting appliance and device connection.

### BRIEF DESCRIPTION OF THE DRAWINGS

FIG. 1 is a perspective view illustrating an illuminated power strip, constructed in accordance with the present invention, in an unpowered state showing an activation switch, a series of available power sockets, and a plug in power cord.

FIG. 2 is a perspective view illustrating the illuminated power strip of FIG. 1, constructed in accordance with the present invention, in a powered state showing the power sockets lighting when the power is turned on.

FIG. 3 is a perspective view illustrating another embodiment of the illuminated power strip, constructed in accordance with the present invention, in an unpowered state showing an activation switch, a series of available power sockets, and a plug in power cord.

FIG. 4 is a perspective view illustrating the illuminated power strip of FIG. 3, constructed in accordance with the present invention, in a powered state showing peripheral borders of the power sockets lighting when the power is turned on.

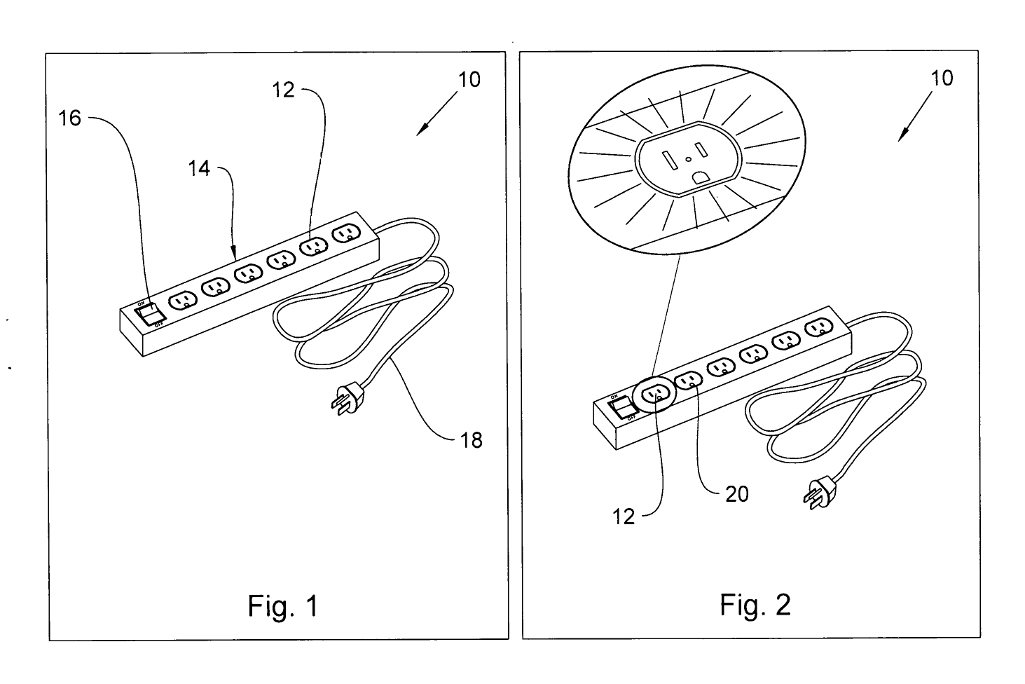

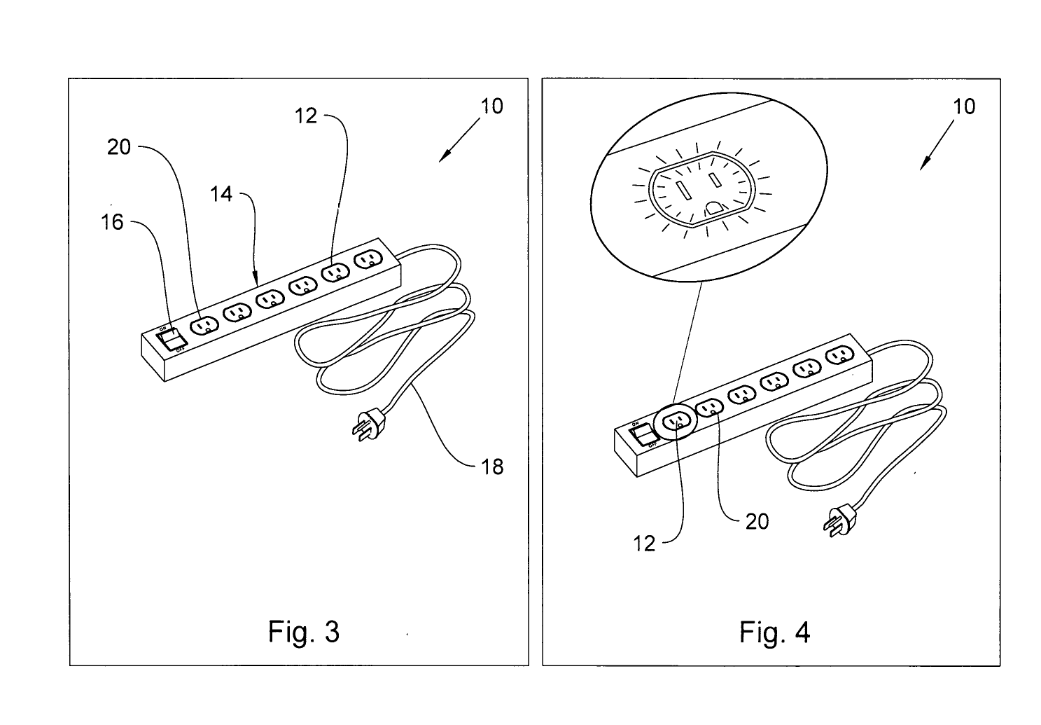

### DETAILED DESCRIPTION OF THE INVENTION

The present invention, hereinafter referred to as an Illuminated Power Strip, indicated generally at 10, is an improved surge protector that comprises illuminated outlets making it easier to see plug sockets 12 and expedite appliance and device connection. While the Illuminated Power Strip 10 is preferably rectangular in shape, it is within the scope of the present invention for the Illuminated Power Strip 10 to be any shape.

The Illuminated Power Strip 10 of the present invention comprises a housing 14 having a top surface, a pair of end surfaces, and a pair of side surfaces. Preferably, the housing 14 is constructed from a shatterproof plastic casing although constructing the housing 14 from a different material is within the scope of the present invention. The housing 14 includes all electronic components needed for the operation of the Illuminated Power Strip 10 and preferably measures approximately twelve (12″) inches in length and two and one quarter (2¼) inches in width although having a housing 14 having a greater length and/or width and/or a lesser length and/or width is within the scope of the present invention.

In addition, the Illuminated Power Strip 10 of the present invention includes an activation switch 16 or ON/OFF switch positioned on one end of the housing 14. Preferably, the activation switch 16 is mounted to a top surface of the housing 14 although mounting the activation switch 16 to another surface of the housing 14 is within the scope of the present invention. The activation switch 16 can be a simple toggle switch or push button switch depending on the desires of the manufacturer and user. The activation switch 16 controls a surge protector as well as provides a standard indicator light when the Illuminated Power Strip 10 is plugged in and turned on.

Furthermore, the Illuminated Power Strip 10 of the present invention includes an integrated three pronged master plug 18 extending from one end surface of the housing 14. Preferably, the master plug 18 is positioned on the opposite end of the housing 14 to which the activation switch 16 is mounted so as not to interfere with the operation of the activation switch 16. Also, preferably, the master plug 18 is compatible with any Ground Fault Circuit Interrupter or GFCI power outlet.

The Illuminated Power Strip 10 of the present invention additionally includes a plurality of power sockets 12 spaced across one or more surfaces of the housing 14. In a preferred embodiment, the plurality of power sockets 12 includes six, three-pronged power sockets 12 spaced evenly along the top surface of the housing 14. Each of the power sockets 12 are designed and shaped to accommodate any two pronged or three pronged electrical plug.

In an embodiment of the present invention, the Illuminated Power Strip 10 of the present invention includes transparent or translucent power sockets 12 and a lighting device 20 mounted below each power socket 12. Preferably, each lighting device 20 is a light emitting diode (LED) although other types of lighting devices 20 are within the scope of the present invention. When the Illuminated Power Strip 10 is powered, each lighting device 20 illuminates thereby illuminating each power socket 12 thereby ensuring that each power socket 12 is easily viewable in all light conditions.

In another embodiment of the present invention, the Illuminated Power Strip 10 of the present invention includes a lighting device 20 surrounding each power socket 12. Preferably, each lighting device 20 is a light emitting diode (LED) although other types of lighting devices 20 are within the scope of the present invention. When the Illuminated Power Strip 10 is powered, each power socket 12 is illuminated in a circle of illumination thereby ensuring that each power socket 12 is easily viewable.

Use of the Illuminated Power Strip 10 of the present invention is simple and straightforward. The master plug 18 of Illuminated Power Strip 10 plugs directly into a wall outlet. Once the Illuminated Power Strip 10 is powered by pressing the activation switch 16 to the On position, each individual power socket 12 is rendered instantly visible by a lighting device 20 positioned either directly under each power socket 12 or by a lighting device 20 surrounding each power socket 12. Each accessory plug is immediately connectable to one of the power sockets 20 without guesswork that usually occurs in small darkened spaces.

Accommodating up to approximately six plugs or more, the Illuminated Power Strip 10 alleviates many dangers resulting from unviewable tangled power cords becoming tripping hazards. Containing a surge protector, the Illuminated Power Strip 10 effectively prevents power surges from damaging electronics and reduces fire hazards germane with electrical appliances. Constructed for general household use, the Illuminated Power Strip 10 is highly functional and operable in businesses and other service establishments. Durably constructed, the Illuminated Power Strip 10 will withstand years of reliable use, with ease.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A power strip for powering a variety of electronics and devices, the power strip comprising:
a housing having a top surface, a pair of end surfaces, and a pair of side surfaces;
a three pronged master plug extending from the housing for providing power to the power strip;
an activation switch mounted on the housing, the activation switch alternatingly powering on and powering off the power strip;
a least one power socket mounted to the housing; and
at least one lighting device mounted to the housing for illuminating the at least one power socket;
wherein the at least one lighting device illuminates the at least one power socket improving the visibility of the at least one power socket and expediting appliance and device connection.

2. The power strip of claim 1 wherein the housing has a substantially rectangular shape.

3. The power strip of claim 1 wherein the housing has a shatterproof plastic casing.

4. The power strip of claim 1 and further comprising:
a surge protector mounted within the housing;
wherein the surge protector activates upon powering on of the power strip.

5. The power strip of claim 1 wherein the activation switch is mounted to the top surface of the housing.

6. The power strip of claim 1 wherein the activation switch is a toggle switch or push button switch.

7. The power strip of claim 1 wherein the master plug extends from an end surface of the housing and is positioned on the opposite end of the housing to which the activation switch is mounted.

8. The power strip of claim 1 and further comprising:
a plurality of three-pronged power sockets spaced evenly along the top surface of the housing.

9. The power strip of claim 1 wherein the at least one power socket is transparent or translucent, the at least one lighting device mounted below the at least one power socket.

10. The power strip of claim 9 and further comprising:
a plurality of power sockets; and
a plurality of lighting devices;
wherein a single lighting device is positioned below a single power socket.

11. The power strip of claim 1 and further comprising:
a plurality of power sockets; and
a plurality of lighting devices.;
wherein a single lighting device surrounds a single power socket, each light surrounded power socket illuminated in a circle of illumination.

12. The power strip of claim 1 wherein the at least one lighting device is a light emitting diode (LED).

13. A method for powering a variety of electronics and devices, the method comprising:
providing a housing having a top surface, a pair of end surfaces, and a pair of side surfaces;
extending a three pronged master plug from the housing;
mounting an activation switch on the housing;
alternatingly powering on and powering off the power strip;
mounting a least one power socket to the housing;
mounting at least one lighting device to the housing for illuminating the power sockets;
illuminating the power sockets; and
improving the visibility of the power sockets to expedite appliance and device connection.

14. A power strip for powering a variety of electronics and devices, the power strip comprising:
a housing having a top surface, a pair of end surfaces, and a pair of side surfaces;
a three pronged master plug extending from one of the end surfaces of the housing for providing power to the power strip;
a surge protector mounted within the housing;
an activation switch mounted on the top surface of the housing, the activation switch alternatingly powering on and powering off the power strip;
a plurality of power sockets mounted to the housing; and
at least one lighting device mounted to the housing for illuminating the plurality of power sockets;
wherein the at least one lighting device illuminates the plurality of power sockets improving the visibility of the plurality of power sockets and expediting appliance and device connection.

15. The power strip of claim 14 wherein the activation switch is selected from the group consisting of a toggle switch and a push button switch.

16. The power strip of claim 14 wherein the master plug is positioned on the opposite end of the housing to which the activation switch is mounted.

17. The power strip of claim 14 wherein the plurality of power sockets are three-pronged power sockets spaced evenly along the top surface of the housing.

18. The power strip of claim 14 wherein each of the plurality of power sockets is transparent or translucent, the at least one lighting device mounted below the plurality of power sockets.

19. The power strip of claim 18 and further comprising:
a plurality of lighting devices;
wherein a single lighting device is positioned below a single power socket.

20. The power strip of claim 14 and further comprising:
a plurality of lighting devices;
wherein a single lighting device surrounds a single power socket, each light surrounded power socket illuminated in a circle of illumination.
